(19) United States
(12) Patent Application Publication
(10) Pub. No.: US 2025/0162144 A1
(43) Pub. Date: May 22, 2025

(54) TASK SPACE OUTER-LOOP INTEGRATED DISTURBANCE OBSERVER AND ROBOT INCLUDING THE SAME

(71) Applicants: NAU ROBOTICS CO., LTD, Incheon (KR); DAEGU GYEONGBUK INSTITUTE OF SCIENCE AND TECHNOLOGY, Daegu (KR)

(72) Inventors: Sehoon OH, Daegu (KR); Kangwagye SAMUEL, Daegu (KR); Bumgil KIM, Incheon (KR); Kunkook LEE, Incheon (KR)

(73) Assignees: NAU ROBOTICS CO., LTD, Incheon (KR); DAEGU GYEONGBUK INSTITUTE OF SCIENCE AND TECHNOLOGY, Daegu (KR)

(21) Appl. No.: 18/442,344

(22) Filed: Feb. 15, 2024

(30) Foreign Application Priority Data
Nov. 22, 2023 (KR) 10-2023-0162969

(51) Int. Cl. B25J 9/16; B25J 13/08

(52) U.S. Cl. CPC B25J 9/1633; B25J 9/1653; B25J 13/085; B25J 13/088

(57) ABSTRACT

The present disclosure relates to a task space outer-loop integrated disturbance observer, and a robot including the same. The task space outer-loop integrated disturbance observer is implemented on an outside of a position and velocity control loop in a task space, and the task space outer-loop integrated disturbance observer acquires a disturbance estimate value by integrating a velocity command value, measured velocity value, an inverse model of velocity control system, and a measured force/torque sensor (F/T sensor) value. The disturbance estimate value is expressed in Equation 1: \hat{D}ᵥ(s)=Q(s)[ [symbol] ₙ⁻¹(s) [symbol] ₘ(s)− [symbol] ᵢ(s)]+A(s)[1−Q(s)] [symbol] ₘ(s) wherein \hat{D}ᵥ(s) is the disturbance estimate value, Q(s) is a “Q” filter, Dₙ(s) is a nominal model, Vₘ(s) is a measured velocity value, and Vᵢ(s) is a velocity command value, A(s) is an admittance target value, and Fₘ(s) is a measured force value.

### CROSS-REFERENCE TO RELATED APPLICATIONS

A claim for priority under 35 U.S.C. § 119 is made to Korean Patent Application No. 10-2023-0162969 filed on Nov. 22, 2023, in the Korean Intellectual Property Office, the entire contents of which are hereby incorporated by reference.

### BACKGROUND

Embodiments of the inventive concept described herein relate to a task space outer-loop integrated disturbance observer, and a robot including the same.

An admittance control may improve a performance and a robustness of a robot in human-robot interactive tasks, but there are limitations in terms of stability when the admittance is implemented on low admittance hardware, such as an industrial robot with a position control. This instability is caused by deviations from an ideal reference model due to an internal loop bandwidth, a time delay, or other model errors.

### SUMMARY

The inventive concept provides a task space outer-loop integrated disturbance observer that may improve a contact stability and an admittance rendering accuracy, and a robot including the same.

The technical objects of the inventive concept are not limited to the above-mentioned ones, and the other unmentioned technical objects will become apparent to those skilled in the art from the following description.

According to an aspect of the inventive concept, there is provided a task space outer-loop integrated disturbance observer implemented on an outside of a position and velocity control loop in a task space, and that acquires a disturbance estimate value by integrating a velocity command value, measured velocity value, an inverse model of velocity control system, and a measured force/torque sensor (F/T sensor) value, and the disturbance estimate value is expressed in the following equation,

$${\hat{D}}_{V} ( s ) = Q ( s ) [ {𝔇}_{n}^{- 1} ( s ) {𝒱}_{m} ( s ) - {𝒱}_{i} ( s ) ] + A ( s ) [ 1 - Q ( s ) ] {ℱ}_{m} ( s ) \qquad [ Equation ]$$

wherein \hat{D}ᵥ(s) is the disturbance estimate value, Q(s) is a “Q” filter, Dₙ(s) is a nominal model, Vₘ(s) is a measured velocity value, and Vᵢ(s) is a velocity command value, A(s) is an admittance target value, and Fₘ(s) is a measured force value.

According to another aspect of the inventive concept, a robot that controls position and velocity in a work space includes a robot manipulator, an F/T sensor coupled to a tool end of the robot manipulator, and a robot controller connected to the F/T sensor and including a task space outer-loop integrated disturbance observer, the task space outer-loop integrated disturbance observer is implemented on an outside of a position and velocity control loop in the task space, and acquires a disturbance estimate value by integrating a velocity command value, measured velocity value, an inverse model of velocity control system, and a measured force/torque sensor (F/T sensor) value, and the disturbance estimate value is expressed in the following equation,

$${\hat{D}}_{V} ( s ) = Q ( s ) [ {𝔇}_{n}^{- 1} ( s ) {𝒱}_{m} ( s ) - {𝒱}_{i} ( s ) ] + A ( s ) [ 1 - Q ( s ) ] {ℱ}_{m} ( s ) \qquad [ Equation ]$$

wherein \hat{D}ᵥ(s) is a disturbance estimate value, Q(s) is a “Q” filter, Dₙ(s) is a nominal model, Vₘ(s) is a measured velocity value, and Vᵢ(s) is a velocity command value, A(s) is an admittance target value, and Fₘ(s) is a measured force value.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view schematically illustrating an admittance control system including a task space outer-loop integrated disturbance observer according to an embodiment of the inventive concept; and

FIG. 2 is a view schematically illustrating a robot including a task space outer-loop integrated disturbance observer according to another embodiment of the inventive concept.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

In this specification, “dynamics” is used instead of a dynamic model, a dynamic model equation, or a simplified expression of dynamic equations, equations of motion, and the like.

A robot has to be able to safely render its dynamic range for physical interactions with an external environment or humans. In an interactive control, such as an impedance control or an admittance control, a force and a velocity of the robot are controlled to respond to an external force or velocity, respectively.

Stability is very important in an interactive control. Unknown environmental dynamics is coupled to the robot, altering its dynamics and potentially causing vibrations or instability. Contact transitions or collisions may temporarily cause large forces. The stability issues become even more important when the robot comes into a contact with highly rigid environments.

In many industrial application fields, a payload of the robot includes a bulky or heavy object, in which case an industrial robot offers a higher payload capacity or reach. The interactive system typically performs an admittance control.

Meanwhile, a disturbance observer is used to suppress a disturbance and effectively improve an internal control loop. The Disturbance observer is well known as an established method for suppressing the effects of a disturbance.

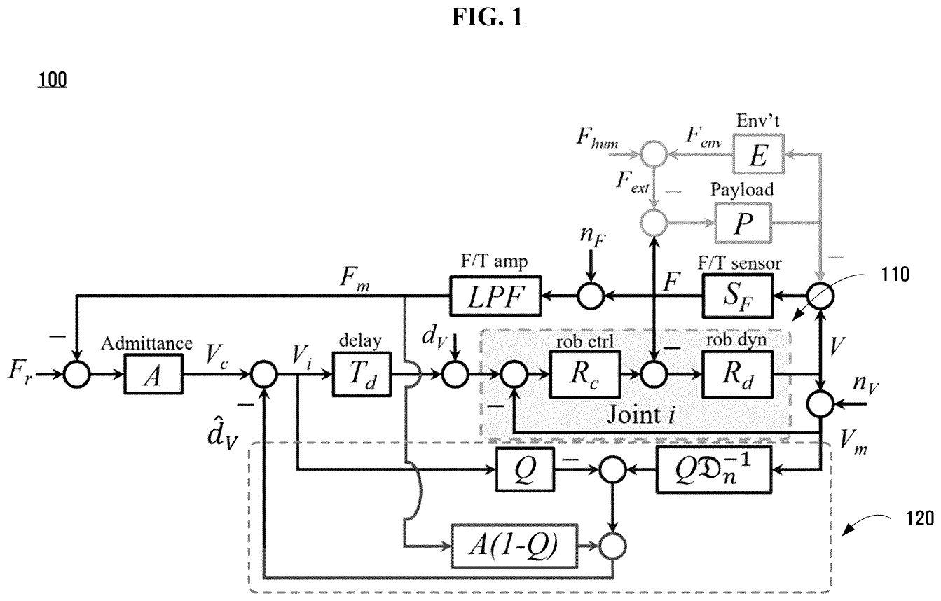

FIG. 1 is a view schematically illustrating an admittance control system including a task space outer-loop integrated disturbance observer according to an embodiment of the inventive concept.

Referring to FIG. 1, an admittance control system 100 includes an internal position/velocity control loop 100 fixed with respect to a joint “i”.

The task space outer-loop integrated disturbance observer 120 is implemented on an outside of a position and velocity control loop 110 in a task space.

The task space outer-loop integrated disturbance observer acquires a disturbance estimate value by integrating a velocity command value, measured velocity value, an inverse model of velocity control system (or a loop), and a measured force/torque sensor (F/T sensor) value.

The disturbance estimate value may be expressed in Equation 1 below.

$${\hat{D}}_{V} ( s ) = Q ( s ) [ {𝔇}_{n}^{- 1} ( s ) {𝒱}_{m} ( s ) - {𝒱}_{i} ( s ) ] + A ( s ) [ 1 - Q ( s ) ] {ℱ}_{m} ( s ) \qquad [ Equation 1 ]$$

Here, \hat{D}ᵥ(s) represents a disturbance estimate value, Q(s) represents a “Q” filter, Dₙ(s) represents a nominal model, Vₘ(s) represents a measured velocity value, and Vᵢ(s) represents a velocity command value, A(s) represents an admittance target value, and Fₘ(s) represents a measured force value.

Here, 1−Q(s) provides properties that suppress high-frequency vibrations due to contact dynamics, thereby improving an overall contact stability. By multiplying the admittance target value A(s), an additional advantage of not only converting a force to a velocity, but also forming force information for tracking the admittance target value arises.

Furthermore, the velocity command value may include an auxiliary velocity command value (V_{c}) and a disturbance estimate value.

Furthermore, the auxiliary velocity command value may be a force value including a reference internal force value (Fᵣ) and a measured force value converted into a velocity by an admittance controller.

Furthermore, a nominal model is designed from internal velocity closed loop dynamics and includes a payload suppressing function, and may be expressed in Equation 2 below.

$${𝔇}_{n} ( s ) = \frac{{R}_{cn} {R}_{dn}}{1 + {R}_{cn} {R}_{dn} ( 1 - {AP}_{n}^{- 1} )} \qquad [ Equation 2 ]$$

Here, R_{cn} represents motor-side nominal dynamics, R_{dn} represents robot nominal dynamics, and P₁ represents payload nominal dynamics, respectively.

Furthermore, the motor-side nominal dynamics may be expressed in Equation 3 below.

$${R}_{cn} ( s ) = {k}_{pn} + {k}_{in} / s \qquad [ Equation 3 ]$$

Here, kₚₙ represents a proportionality coefficient and kᵢₙ represents an integration coefficient.

Furthermore, the robot nominal dynamics may be expressed in Equation 4 below.

$${R}_{dn} ( s ) = \frac{1}{{M}_{rn} s + {B}_{rn}} , {M}_{rn} = {M}_{r 1} + {M}_{r 2} and {B}_{rn} = {B}_{r 1} + {B}_{r 2} \qquad [ Equation 4 ]$$

Here, Mᵣ₁ represents a joint-side mass, Mᵣ₂ represents a link-side mass, Bᵣ₁ represents a joint-side damping coefficient, and Bᵣ₂ represents a link-side damping coefficient.

Furthermore, the payload nominal dynamics may be expressed in Equation 5 below.

$${P}_{n} = 1 / {M}_{pn} s , {M}_{pn} \leq {M}_{a} \qquad [ Equation 5 ]$$

Here, Mₚₙ represents a payload mass and Mₐ represents an admittance mass, respectively.

Furthermore, the admittance target value may be expressed in Equation 6 below.

$$A ( s ) = \frac{1}{{M}_{a} s + {B}_{a}} \qquad [ Equation 6 ]$$

Here, Mₐ represents an admittance mass and Bₐ represents an admittance damping coefficient.

Furthermore, the robot dynamics R_{d}(s) in the system 100 illustrated in FIG. 1 may be interpreted as a linear two-mass system, and may be simplified and expressed in Equation 7 below.

$${R}_{d} ( s ) = \frac{𝒱 ( s )}{{ℱ}_{c} ( s )} = \frac{{R}_{d 1} ( s ) ( 1 + {K}_{s} ( s ) {R}_{d 2} ( s ) )}{1 + {K}_{s} ( s ) ( {R}_{d 1} ( s ) + {R}_{d 2} ( s ) )} \qquad [ Equation 7 ]$$

Here, R_{d1}(s) represents motor side dynamics, R_{d2}(s) represents link side dynamics, and Kₛ(s) represents joint flexibility dynamics.

In addition, the F/T sensor and the external environment are modeled as stiff springs, and the payload is modeled as pure inertia, and each may be expressed as Equation 8 below.

$${S}_{F} ( s ) = \frac{{K}_{f}}{s} , E ( s ) = \frac{{K}_{e}}{s} , and P ( s ) = \frac{1}{{M}_{p} s} \qquad [ Equation 8 ]$$

Here, K_{f} represents a F/T sensor rigidity, Kₑ represents an external environment rigidity, and Mₚ represents a payload mass.

A basic admittance control of system 100 illustrated in FIG. 1 is realized by an external feedback of measurements of the F/T sensor.

An analog low-pass filter (LPF) in an F/T amplifier may be designed to have a cutoff frequency of a desired value to reduce a force measurement delay.

An external force may act on the robot from a user (human), an environment, or a combination thereof, physically affecting the dynamics of the robot. The external force is measured by the F/T sensor.

The external force Fₑₓₜ includes a human force Fₕᵤₘ and an environmental force Fₑₙᵥ. Fr represents a reference internal force value. An error between the force reference value and the measured force value is input to the admittance controller to generate a velocity command value.

The velocity command value Vᵢ is input to the robot controller R_{c} and the robot dynamics R_{d}.

Depending on the velocity command value, the robot moves at a velocity “V” and generates a force “F”.

dᵥ represents a disturbance that is input to the system, and T_{d} represents an input time delay.

The internal task space motion control loop may track motion commands that are provided by the admittance controller.

An admittance control is realized for a tool center point (TCP), which is a reference point that defines a position and a direction of a tool mounted on the robot.

The measured force value is converted to a frame (or a coordinate system) that is defined by the tool center point, and the motion command of the robot also is made in this frame.

To describe the gist of the inventive concept, there are some unmentioned contents related to the system 100 illustrated in FIG. 1, but its implementation process and operational effects will be fully understandable to those skilled in the art.

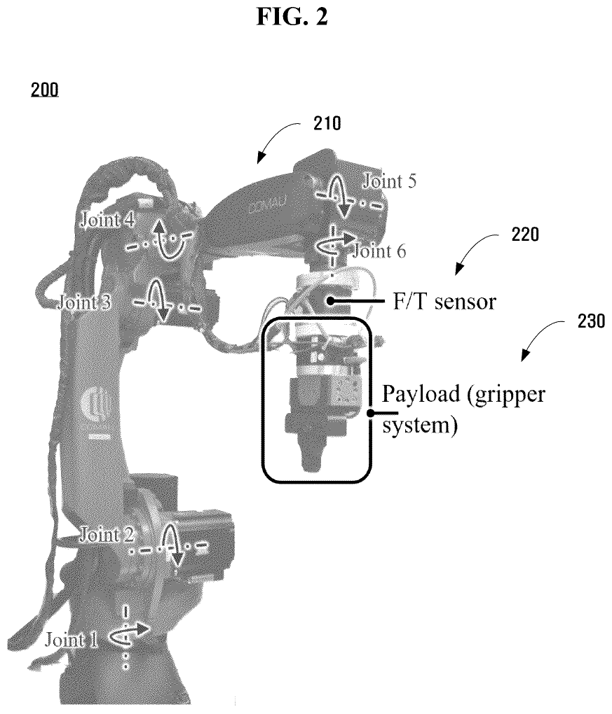

FIG. 2 is a view schematically illustrating a robot including a task space outer-loop integrated disturbance observer according to another embodiment of the inventive concept.

Referring to FIG. 2, the robot 200 includes a robot manipulator 210, an F/T sensor 220, a robot controller (not illustrated), and a payload or gripper system 230.

The robot 200 according to the embodiment of the inventive concept may be a robot that controls a position and a velocity in a task space.

FIG. 2 illustrates a robot manipulator 210 with 6 degrees of freedom, but the robot manipulator 210 is not limited thereto, and the embodiment of the inventive concept may be implemented by using various robot manipulators, such as a horizontal or vertical multi-joint robot manipulator with an arbitrary degree of freedom, an orthogonal robot manipulator, a scara robot manipulator, and a delta robot manipulator.

The F/T sensor 220 is coupled to a tool end of the robot manipulator 210.

The robot controller is connected to the F/T sensor 220, and includes the task space outer-loop integrated disturbance observer described with reference to FIG. 1.

Depending on the embodiment, such as an application field, the gripper or the payload or gripper system 230 may be coupled to and fixed to the F/T sensor 220.

According to the disclosed embodiment, a disturbance may be estimated by integrating the velocity command value, measured velocity value, inverse model of velocity control system, and measurements of the F/T sensor, and may be removed.

According to the disclosed embodiment, by improving the accuracy of rendering an admittance of the robot to the user or the environmental force, the robot may be easier to manipulate, reduce contact forces with the environment, and minimize vibration.

According to the disclosed embodiment, by implementing a disturbance observer on an outside of the position and velocity control loop, the influences of the robot and payload dynamics and the time delays in the task space may be offset.

According to the disclosed embodiment, contact stability may be significantly improved by suppressing high-frequency contact dynamics by utilizing the measurements of the F/T sensor in the task space.

According to the disclosed embodiment, an admittance control method with a simple structure may be implemented in an industrial robot such that the industrial robot is converted into a collaborative robot.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A task space outer-loop integrated disturbance observer implemented on an outside of a position and velocity control loop in a task space, and configured to acquire a disturbance estimate value by integrating a velocity command value, measured velocity value, an inverse model of velocity control system, and a measured force/torque sensor (F/T sensor) value, wherein
wherein the disturbance estimate value is expressed in Equation 1 below,
$${\hat{D}}_{V} ( s ) = Q ( s ) [ {𝔇}_{n}^{- 1} ( s ) {𝒱}_{m} ( s ) - {𝒱}_{i} ( s ) ] + A ( s ) [ 1 - Q ( s ) ] {ℱ}_{m} ( s ) \qquad [ Equation 1 ]$$
wherein \hat{D}ᵥ(s) is the disturbance estimate value, Q(s) is a “Q” filter, Dₙ(s) is a nominal model, Vₘ(s) is a measured velocity value, and Vᵢ(s) is a velocity command value, A(s) is an admittance target value, and Fₘ(s) is a measured force value.

2. The task space outer-loop integrated disturbance observer of claim 1, wherein the velocity command value includes an auxiliary velocity command value (V_{c}) and the disturbance estimate value.

3. The task space outer-loop integrated disturbance observer of claim 2, wherein the auxiliary velocity command value is a force value including a reference internal force value (Fᵣ) and the measured force value, which is converted to a velocity by an admittance controller.

4. The task space outer-loop integrated disturbance observer of claim 1, wherein the nominal model is designed from internal velocity closed loop dynamics and includes a payload suppressing function, and is expressed in Equation 2 below,
$${𝔇}_{n} ( s ) = \frac{{R}_{cn} {R}_{dn}}{1 + {R}_{cn} {R}_{dn} ( 1 - {AP}_{n}^{- 1} )} \qquad [ Equation 4 ]$$
wherein R_{cn} is motor-side nominal dynamics, R_{dn} is robot nominal dynamics, and Pₙ is payload nominal dynamics.

5. The task space outer-loop integrated disturbance observer of claim 4, wherein the motor-side nominal dynamics is expressed in Equation 3 below,
$${R}_{cn} ( s ) = {k}_{pn} + {k}_{in} / s \qquad [ Equation 3 ]$$
kₚₙ is a proportionality coefficient and kᵢₙ is an integration coefficient.

6. The task space outer-loop integrated disturbance observer of claim 4, wherein the robot nominal dynamics is expressed in Equation 4,
$${R}_{dn} ( s ) = \frac{1}{{M}_{rn} s + {B}_{rn}} , {M}_{rn} = {M}_{r 1} + {M}_{r 2} and {B}_{rn} = {B}_{r 1} + {B}_{r 2} \qquad [ Equation 4 ]$$
wherein Mᵣ₁ is a joint-side mass, Mᵣ₂ is a link-side mass, Bᵣ₁ is a joint-side damping coefficient, and Bᵣ₂ is a link-side damping coefficient.

7. The task space outer-loop integrated disturbance observer of claim 4, wherein the payload nominal dynamics is expressed in Equation 5 below,
$${P}_{n} = 1 / {M}_{pn} s , {M}_{pn} \leq {M}_{a} \qquad [ Equation 5 ]$$
the Mₚₙ is a payload mass and Mₐ is an admittance mass.

8. The task space outer-loop integrated disturbance observer of claim 1, wherein the admittance target value is expressed in Equation 6 below,
$$A ( s ) = \frac{1}{{M}_{a} s + {B}_{a}}$$
wherein Mₐ is an admittance mass and Bₐ is an admittance damping coefficient.

9. A robot configured to control position and velocity in a work space, the robot comprising:
a robot manipulator;
an F/T sensor coupled to a tool end of the robot manipulator; and
a robot controller connected to the F/T sensor and including a task space outer-loop integrated disturbance observer,
wherein the task space outer-loop integrated disturbance observer is implemented on an outside of a position and velocity control loop in the task space, and acquires a disturbance estimate value by integrating a velocity command value, measured velocity value, an inverse model of velocity control system, and a measured force/torque sensor (F/T sensor) value,
wherein the disturbance estimate value is expressed in Equation 7 below,
$${\hat{D}}_{V} ( s ) = Q ( s ) [ {𝔇}_{n}^{- 1} ( s ) {𝒱}_{m} ( s ) - {𝒱}_{i} ( s ) ] + A ( s ) [ 1 - Q ( s ) ] {ℱ}_{m} ( s ) \qquad [ Equation 7 ]$$
wherein \hat{D}ᵥ(s) is a disturbance estimate value, Q(s) is a “Q” filter, Dₙ(s) is a nominal model, Vₘ(s) is a measured velocity value, and Vᵢ(s) is a velocity command value, A(s) is an admittance target value, and Fₘ(s) is a measured force value.
